(19) United States
(12) Patent Application Publication
(10) Pub. No.: US 2024/0054356 A1
(43) Pub. Date: Feb. 15, 2024

(54) SYSTEMS AND METHODS FOR GENERATING MULTIPURPOSE GRAPH NODE EMBEDDINGS FOR MACHINE LEARNING

(71) Applicant: Capital One Services, LLC, McLean, VA (US)

(72) Inventors: Jiankun LIU, Flower Mound, TX (US); Aamer CHARANIA, Flower Mound, TX (US); Behrouz SAGHAFI KHADEM, Frisco, TX (US)

(73) Assignee: Capital One Services, LLC, McLean, VA (US)

(21) Appl. No.: 17/819,248

(22) Filed: Aug. 11, 2022

(51) Int. Cl. G06N 5/02

(52) U.S. Cl. CPC G06N 5/022

(57) ABSTRACT

In some aspects, a computing system may create different node embeddings (e.g., different instances of the same graph) and aggregate the node embeddings to form “multipurpose” node embeddings. As an example, the different node embeddings may include node embeddings generated using unsupervised machine learning and node embeddings generated using supervised machine learning. In this way, for example, a variety of machine learning models may use the aggregated node embeddings without the need for each machine learning model to generate separate node embeddings each time a machine learning task is performed. A machine learning model may use all or a portion of the features in the aggregated node embeddings as appropriate for the task the model is performing.

### BACKGROUND

Data can be represented as a graph of relationships and interactions between objects. Graphs may include nodes and edges that connect nodes with each other. In some cases, nodes in a graph represent objects, and relationships are represented as edges between nodes. Graph data can be used by machine learning models to perform a variety of tasks including classification, clustering, and regression. For example, machine learning models may be used to perform node classification, link prediction, community detection, or graph classification.

### SUMMARY

Node embeddings may be used to assist machine learning models to perform tasks with graph data. Node embeddings may encode or represent nodes such that two nodes that are similar in a graph have similar node embeddings. In many pre-existing systems, a machine learning model may need to generate node embeddings before graph data can be used in a machine learning task. Although different machine learning tasks may use different types of node embeddings, creating a different set of node embeddings (e.g., using different embedding techniques) from graph data each time a new machine learning task must be performed is inefficient due to the vast amount of computing resources it takes to generate each set of node embeddings. Further, in some cases, when many pre-existing systems create node embeddings for a specific task, the node embeddings may be missing some features that, although useful to include in the node embeddings for the task, were not included in the node embeddings.

To address these issues, non-conventional methods and systems described herein generate “multipurpose” node embeddings that can be used for a variety of machine learning tasks. Systems and methods described herein may generate multiple different node embeddings that may be aggregated in one or more ways. Aggregating different types of node embeddings to create the aggregated node embeddings may allow a variety of machine learning models to use the aggregated node embeddings without the need for each machine learning model to generate separate node embeddings. A machine learning model can then use all features or a portion of the features in the aggregated node embeddings, as appropriate, for the task the model is performing. In this way, for example, increased efficiency may be provided via the aggregated set of node embeddings because the need for each machine learning application to create separate node embeddings (e.g., for each different type of task) may be avoided. Additionally, or alternatively, the aggregated set of node embeddings may provide increased improvement (e.g., precision, recall, accuracy, etc.) to machine learning models due to the combination of multiple different node embeddings. For example, by aggregating multiple different sets of node embeddings, machine learning models have access to additional information (e.g., because the node embeddings have more features or better features) that improves the performance of the models.

In some aspects, a system may generate, based on a graph including a plurality of nodes, a first set of node embeddings via a first embedding model and a second set of node embeddings via a second embedding model. The system may aggregate the first set of node embeddings and the second set of node embeddings into an aggregated set of node embeddings. The aggregated set of node embeddings may include an aggregated node embedding for each node of the plurality of nodes. Each node embedding of the aggregated set of node embeddings may have an aggregated set of features. The system may select a feature subset of the aggregated set of features as input parameters for a machine learning model to predict a target. Selecting the feature subset may include selecting a first feature subset of the aggregated set of features as input parameters for a first machine learning model to predict the first target, for example, in response to the target being a first target and the machine learning model being a first machine learning model. Additionally or alternatively, selecting the feature subset may include selecting a second feature subset of the aggregated set of features as input parameters for the second machine learning model to predict the second target, for example, in response to the target being a second target different from the first target and the machine learning model being a second machine learning model different from the first machine learning model. The system may configure, based on the selection of the feature subset, the machine learning model with the feature subset as input parameters for the machine learning model.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for facilitating configuration of machine learning models for different purposes, in accordance with one or more embodiments.

FIG. 2A shows an example graph, in accordance with one or more embodiments.

FIG. 2B shows example node embeddings, in accordance with one or more embodiments.

FIG. 3 shows illustrative components for a system generating and using node embeddings, in accordance with one or more embodiments.

FIG. 4 shows a flowchart of the steps involved in generating aggregated node embeddings and configuring machine learning models, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

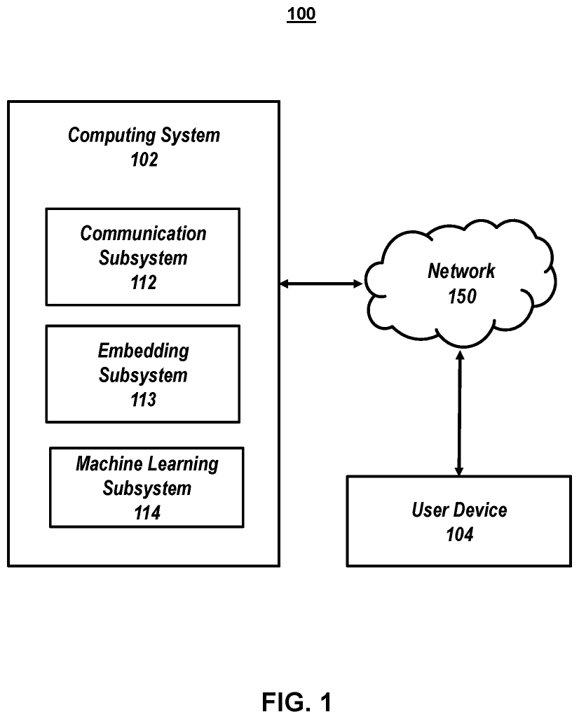

FIG. 1 shows an illustrative system 100 for facilitating configuration of machine learning models for different purposes (e.g., based on “multipurpose” node embeddings generated via aggregation of multi-dimensional data representations of nodes), in accordance with one or more embodiments. The system 100 has numerous practical applications of machine learning models. For example, the system 100 can provide multipurpose or aggregated node embeddings for machine learning models that detect objects, determine whether a cyber security intrusion has occurred, detect the presence of cancer in medical data, approve or disapprove a user for a loan or other product offerings, or a variety of other practical applications. Non-conventional methods and systems described herein generate “multipurpose” node embeddings that can be used for a variety of machine learning tasks. The system 100 may generate multiple different node embeddings that may be aggregated in one or more ways. Aggregating different types of node embeddings to create the aggregated node embeddings may allow a variety of machine learning models to use the aggregated node embeddings without the need for each machine learning model to generate separate node embeddings. A machine learning model can then use all features or a portion of the features in the aggregated node embeddings as appropriate for the task the model is performing. In this way, for example, increased efficiency may be provided via the aggregated set of node embeddings because the need for each machine learning application to create separate node embeddings (e.g., for each different type of task) may be avoided. Additionally, or alternatively, the aggregated set of node embeddings may provide increased improvement (e.g., precision, recall, accuracy, etc.) to machine learning models due to the combination of multiple different node embeddings. For example, by aggregating multiple different sets of node embeddings, machine learning models have access to additional information (e.g., because the node embeddings have more features or better features) that improves the performance of the models.

In some embodiments, the system 100 may generate, based on a plurality of nodes, sets of node embeddings via respective embedding models and aggregate the sets of node embeddings into an aggregated set of node embeddings. System 100 may then use one or more feature subsets of the features of the aggregated set of node embeddings to configure one or more machine learning models. As an example, the sets of node embeddings may include a first set of node embeddings generated via a first embedding model, a second set of node embeddings generated via a second embedding model, a third set of node embeddings generated via a third embedding model, and so on. As another example, a first feature subset of the features may be selected as input parameters for a first machine learning model (e.g., to predict a first target), a second feature subset of the features may be selected as input parameters for a second machine learning model to predict a second target, or a third feature subset of the features may be selected as input parameters for a third machine learning model to predict a third target.

In one example, a first set of embeddings may include a first plurality of node embeddings with 300 dimensions each. A second set of embeddings may include a second plurality of node embeddings with 150 dimensions each. In this example, the aggregated embeddings may include 450 dimensions each because the node embeddings from the second set of embeddings are appended onto corresponding nodes from the first set of embeddings.

In one example, a first set of embeddings may include a first plurality of node embeddings with 100 dimensions each. A second set of embeddings may include a second plurality of node embeddings with 100 dimensions each. In this example, the aggregated embeddings may include 100 dimensions each because each node embedding from the second set of embeddings is averaged with a corresponding node embedding from the first set of embeddings.

FIG. 1 illustrates a computing system 102, in accordance with one or more embodiments. The computing system 102 may include a communication subsystem 112, an embedding subsystem 113, a machine learning subsystem 114, or other components. In some embodiments, the communication subsystem 112 may receive graph data from one or more databases. The one or more databases may include a database server, a time series database, a graph database, or a variety of other databases. The graph data may include one or more nodes that are representative of entities, documents, resources, users (e.g., customers), banking products, or a variety of other objects or concepts. An edge connecting two nodes in the graph may indicate a relationship, an event, or any other association between the two nodes. The graph may be a knowledge graph, a heterogeneous graph (e.g., a graph with more than one type of node), and/or a variety of other graphs. Timestamps may be stored (e.g., in the time series database and/or the graph database) and may indicate a date/time that a relationship or association started between two nodes, and/or a date/time that an event occurred involving whatever is represented by the two nodes.

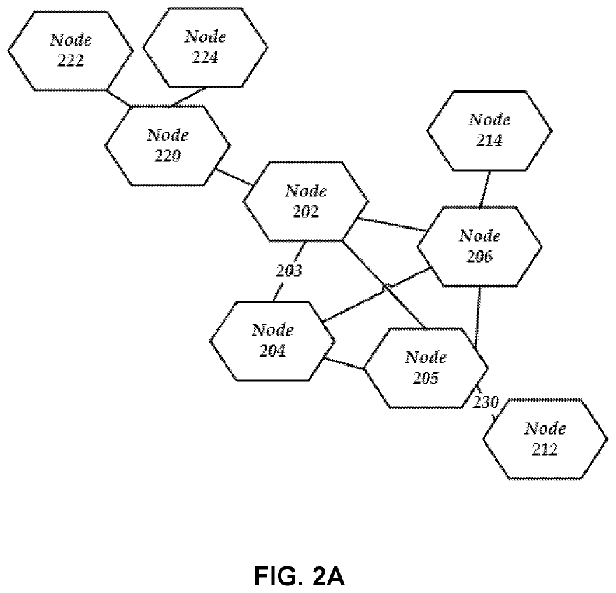

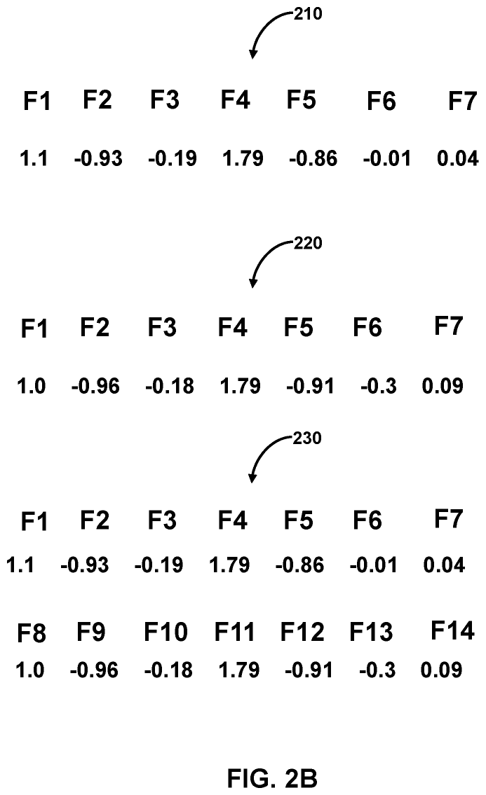

Referring to FIG. 2A, an example graph (e.g., representing an organization) comprising a plurality of nodes and edges is shown. A node may represent or otherwise indicate an employee, person, user, customer, team, product, software code repository, system, dataset, document, resource, project, or a variety of other entities or items. An edge (e.g., edge 203 or edge 230) may indicate an association between two nodes. An edge may indicate an event that two nodes were part of. For example, two nodes representing users of a bank may be connected via an edge because the users performed a transaction with each other. As an additional example, node 202 may be a meeting node indicating a meeting between two or more people. Nodes 204-206 may indicate people that attended the meeting indicated by node 202. Edges connecting each of nodes 204-206 to node 202 may indicate that each person represented by nodes 204-206 attended the meeting indicated by node 202.

In some embodiments, edges connecting nodes 204-206 to each other may indicate that the users represented by nodes 204-206 conducted one or more transactions (e.g., a banking transaction, a blockchain transaction, etc.) with each other. In some embodiments, a team comprising the users represented by nodes 204-206 may be indicated by a team node (not shown in FIG. 2A) and edges connecting nodes 204-206 to the team node may indicate that the users represented by nodes 204-206 are on the same team. An edge may be associated with a timestamp indicating a time at which the edge was created. The timestamp may indicate a time an event occurred that links together two nodes. For example, edge 203 may be associated with a timestamp indicating a date and/or time that the user indicated by node 204 conducted a transaction with the user indicated by node 202.

In some embodiments, node 220 may indicate a project and/or a product (e.g., a software product, banking product, etc.) associated with a transaction represented by node 202. For example, the transaction represented by node 202 may have been performed via a mobile banking application represented by node 220. Nodes 222 and 224 may indicate teams (e.g., a software development, sales, marketing, finance, information technology support, or any other team) that are involved with the product indicated by node 220. For example, node 222 may represent a software development team responsible for creating the product indicated by node 220. As an additional example, node 212 may indicate a banking product that has been granted or denied by a bank for a user indicated by node 205. As another example, node 214 may indicate a document written by a user represented by node 206.

Referring back to FIG. 1, the computing system 102 (e.g., via the embedding subsystem 113) may generate a first set of node embeddings. A node embedding may be a vector (e.g., a list of values) that represents a node. Node embeddings may encode or represent nodes such that two nodes that are similar in a graph have similar node embeddings. Similarity between two node embeddings may be determined via a dot product or a distance metric (e.g., Cosine similarity, Euclidean distance, Manhattan distance, Minkowski distance, etc.). For example, the computing system 102 may determine that two nodes are similar if a distance metric between their corresponding node embeddings is less than a threshold distance. A node embedding may include multiple values. The number of values in a node embedding may be referred to as the number of dimensions. For example, a node embedding may have a dimension of 150, 300, 2000, or a variety of other dimensions.

In some embodiments, a first set of node embeddings may be generated using an unsupervised machine learning technique. An unsupervised machine learning technique may include the use of a machine learning model that learns patterns from unlabeled data (e.g., data without labeled classes). The computing system 102 may generate an unsupervised learning set of node embeddings by inputting data corresponding to graph nodes of a graph into an unsupervised embedding model. The computing system 102 may use a technique that uses the context of a node (e.g., skip-gram with negative sampling and random walks) to generate an embedding for the first set of nodes. For example, the computing system 102 may use Node2vec to generate the unsupervised learning set of node embeddings. The first set of nodes may be generated using a variety of transductive machine learning techniques. The first set of node embeddings may include a different node embedding for each node in a graph. In some embodiments, the first set of node embeddings may include a node embedding for each node of a portion of the nodes in the graph. The graph may include any graph, for example, as described above in connection with FIGS. 1-2. The first set of node embeddings may include any set of node embeddings described above, for example, in connection with FIGS. 1-2.

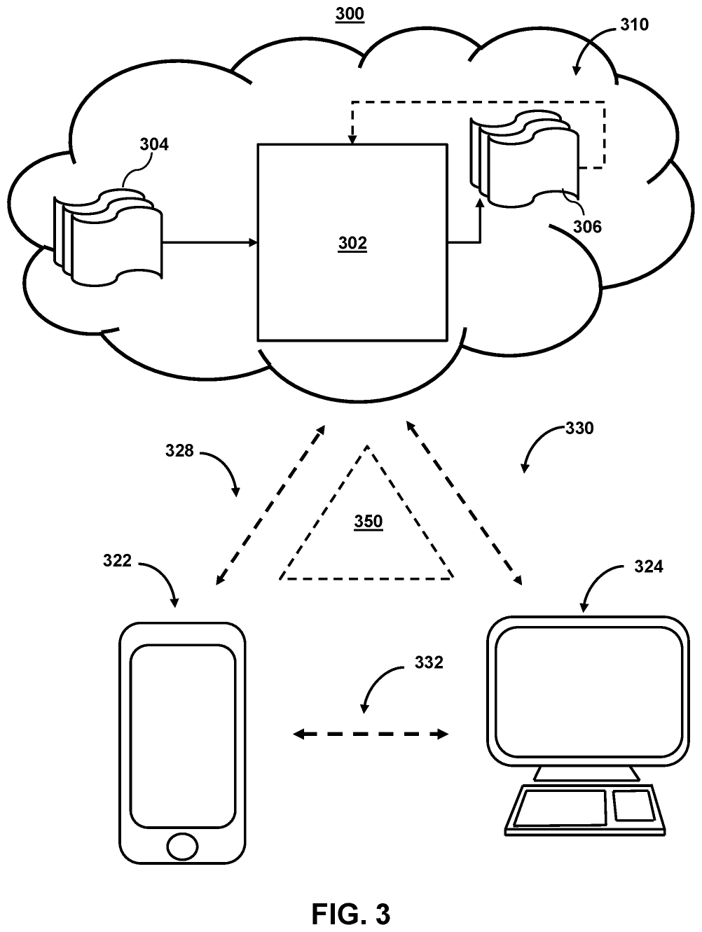

The computing system 102 may generate a second set of node embeddings. The second set of node embeddings may be generated using a supervised machine learning technique. A supervised machine learning technique may include using a machine learning model (e.g., as described below in connection with FIG. 3) that has been trained using a labeled dataset to classify data or predict outcomes. The computing system 102 may generate a supervised learning set of node embeddings by inputting data corresponding to the graph nodes into a supervised embedding model. The computing system 102 may train a machine learning model that uses a node's features (e.g., text attributes, connected nodes, or any other node data described above in connection with FIG. 2A) to generate an embedding for a node. For example, the computing system 102 may use GraphSAGE, GraphSAINT, a graph convolutional network, or a variety of other techniques to generate the second set of node embeddings. The second set of node embeddings may include a different node embedding for each node in a graph. In some embodiments, the second set of node embeddings may include a node embedding for each node of a portion of the nodes in the graph. Each node of the second set of node embeddings may include a second total number of features. The second total number of features may be the same number as the first total number of features described above in connection with step 402. Alternatively, the second total number of features may be a different number from the first total number of features.

In some embodiments, the computing system 102 may generate labels for the graph so that node embeddings can be generated via a supervised machine learning technique. For example, the computing system 102 may determine, based on data associated with a first node, that a first feature is greater than a threshold feature value. Based on determining that the first feature is greater than a threshold feature value, the computing system 102 may assign a first label to the first node.

In some embodiments, additional sets (e.g., 3 sets, 4 sets, 6 sets, 15 sets, etc.) of node embeddings may be generated. For example, the computing system 102 may generate a third set of node embeddings using supervised or unsupervised machine learning techniques, or any other technique described herein. The third set of node embeddings may be aggregated with the first set of node embeddings or the second set of node embeddings, for example, by concatenation, averaging, linear combinations, or a variety of other techniques. Information about a user may be represented differently in multiple dimensions by using multiple sets of node embeddings. For example, a user's salary or income level may be represented differently by each of the first, second, or third set of node embeddings.

The computing system 102 may aggregate the first set of node embeddings with the second set of node embeddings, for example, to create an aggregated set of node embeddings. The aggregated set of node embeddings may include an aggregated node embedding for each node of the graph. Each aggregated node embedding may have an aggregated set of features (e.g., values). The aggregated set of features may be the values of the aggregated node embedding. An aggregated node embedding may include a greater number of features than either the first or second total number of features. For example, an aggregated node embedding may include a concatenation of a first node embedding from the first set of node embeddings with a second node embedding of the second set of node embeddings. In this example, the first node embedding and the second node embedding may correspond to the same node in the graph or different nodes in the graph. Each node embedding in the first set of node embeddings may be concatenated with a corresponding node embedding in the second set of node embeddings to create the aggregated set of node embeddings.

For example, referring to FIG. 2B, example node embeddings are shown. The node embeddings 210 and 220 each contain seven features (e.g., values) F1-F7. The node embedding 210 may have been generated as part of the first set of node embeddings (e.g., as described above) and the node embedding 220 may have been generated as part of the second set of node embeddings (e.g., as described above). The node embedding 210 and the node embedding 220 may both correspond to the node 202 of FIG. 2A. The node embedding 230 is an aggregated node embedding with fourteen features F1-F14. The node embedding 230 may have been generated by the computing system 102 by concatenating the node embedding 210 with the node embedding 220. For example, the features of node embedding 220 are appended on to the end of the features of node embedding 210.

Referring back to FIG. 1, the aggregated set of features may include a variety of combinations of features from the first set of node embeddings and the second set of node embeddings. In some embodiments, aggregating the first set of node embeddings and the second set of node embeddings may include concatenation as described above. In some embodiments, aggregating the first set of node embeddings and the second set of node embeddings may include creating linear combinations with a first node of the first set of node embeddings and a corresponding second node from the second set of node embeddings. For example, the computing system 102 may generate a linear combination of a first node embedding from the first set of node embeddings and a second node embedding from the second set of node embeddings. In this example, the first node embedding and the second node embedding correspond to the same node.

In some embodiments, aggregating the first set of node embeddings and the second set of node embeddings may include averaging the values of two or more node embeddings. For example, the computing system 102 may average a first node embedding from the first set of node embeddings with a second node embedding from the second set of node embeddings. In this example, the first node embedding and the second node embedding correspond to the same node. Averaging the values of two or more node embeddings may include performing a weighted average. For example, each value in each node embedding of the first set of node embeddings may be multiplied by a first weight (e.g., 0.75) and each value in each node embedding of the second set of node embeddings may be multiplied by a second weight (e.g., 0.25). Each weighted node embedding from the first set of node embeddings may then be averaged with its corresponding weighted node embedding from the second set of node embeddings.

In some embodiments, generating aggregated node embeddings may include a combination of the above-described aggregation techniques. For example, for a first portion of the first and second node embeddings, node embeddings may be concatenated and for a second portion of the first and second node embeddings, node embeddings may be averaged. In some embodiments, a first set of node embeddings may be averaged with a second set of node embeddings to form an averaged set of node embeddings. The averaged set of node embeddings may be further aggregated with a third set of node embeddings by concatenating or averaging the averaged set of node embeddings with the third set of node embeddings.

The computing system 102 may select one or more feature subsets of the aggregated node embeddings. The computing system 102 may select different feature subsets of the aggregated node embeddings for different machine learning tasks. The computing system 102 may select a first feature subset as input parameters for a first machine learning model to predict a first target or the computing system 102 may select a second feature subset as input parameters for the second machine learning model to predict a second target different from the first target. For example, the computing system 102 may select a first feature subset for a machine learning model that recommends banking products to users. The computing system 102 may select a second feature subset for a machine learning model that identifies malicious or fraudulent activity in connection with a banking product. The computing system 102 may select a third feature subset for a machine learning model that determines new nodes or edges to add to the graph (e.g., the graph described above in connection with FIG. 2A). The machine learning models may be a linear regression model, a logistic regression model, a random forest model, a neural network, a gradient boosting machine, a model described in connection with FIG. 3 below, or a variety of other models.

In some embodiments, the computing system 102 may select features based on how they affect the performance of one or more machine learning models. For example, the computing system 102 may determine, based on the first feature subset causing the first machine learning model to satisfy a performance threshold, the first feature subset. In some embodiments, the computing system 102 may select features using statistical techniques such as principal component analysis (PCA). For example, using PCA, the computing system 102 may generate a matrix of eigenvectors associated with the aggregated set of node embeddings and select a subset of features of the aggregated set of feature (e.g., where each selected feature in the subset corresponds an eigenvector of a threshold number of eigenvectors). For example, the computing system 102 may select a threshold number of features that correspond to the eigenvectors with the largest eigenvalues.

In some embodiments, a user interface may be generated to display an indication of the features that were selected for use with one or more machine learning models. For example, the computing system 102 may generate a user interface for display at the user device 104. The user interface may include an indication of a subset of features of the aggregated set of node embeddings used by the first machine learning model. The user interface may display the names of the features selected and may include a reason for why the features were selected. For example, the user interface may indicate to what degree the selected features performed better than other combinations of features. In some embodiments, a user may provide input via the user interface to select additional features to use with one or more machine learning models. In some embodiments, a user may provide input via the user interface to remove one or more features from the features selected to be included in the aggregated set of node embeddings.

The computing system 102 may configure one or more machine learning models based on the selected feature subsets. The computing system 102 may use the machine learning subsystem 114 to train the first machine learning model to perform the first task. For example, the first machine learning model may be trained to identify a banking product to recommend to a user. A task performed by a machine learning model may include sending data, processing data, generating a request to receive data via a network, or a variety of other data related actions. A task may include a banking related action or providing a banking product. For example, the task may include approving a loan, issuing a credit card or debit card, opening an account (e.g., a checking account, a savings account, a money market account), increasing a credit limit, issuing a certificate of deposit (CD), processing a mortgage, or a variety of other banking related actions. The task may include determining whether any of the above tasks should be performed. A banking product may include a loan, a card (e.g., credit card, debit card, cryptocurrency card), an account (e.g., a checking account, a savings account, a money market account), a line of credit, a certificate of deposit (CD), a mortgage, cryptocurrency (e.g., Bitcoin, Ethereum, a stable coin, etc.), or a variety of other banking related products. A machine learning model may use a portion of the aggregated node embeddings to determine whether a user should be approved for a banking product.

FIG. 3 shows illustrative components for a system used for configuration of machine learning models for different purposes (e.g., based on “multi-purpose” graph embeddings generated via aggregation of multi-dimensional data representations of nodes), in accordance with one or more embodiments. For example, FIG. 3 shows illustrative components for using distance scores to evaluate quality levels of machine learning explanations. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, mobile devices, and/or any device or system described in connection with FIGS. 1-2. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device, such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the Computing system 102 or the user device 104 described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., using distance scores to evaluate quality levels of machine learning explanations or counterfactual samples).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The model (e.g., model 302) may generate a variety of node embeddings based on a node that is input into the model (e.g., as described above in connection with FIGS. 1-2B). The model may generate aggregated embeddings based on the variety of node embeddings. Additionally or alternatively, the model may be configured (e.g., trained) using an aggregated set of node embeddings as described herein.

System 300 also includes application programming interface (API) layer 350. API layer 350 may allow the system to generate summaries across different devices. In some embodiments, API layer 350 may be implemented on user device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

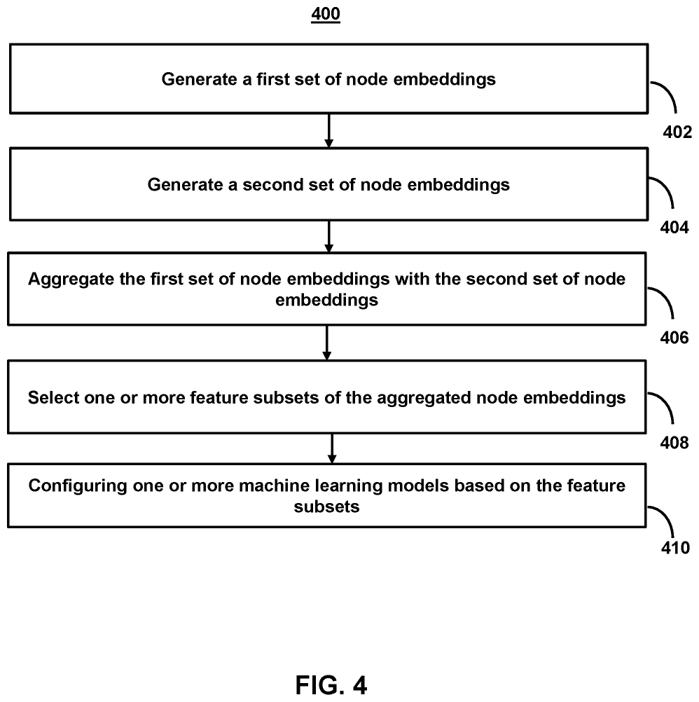

FIG. 4 shows a flowchart of the steps involved in facilitating configuration of machine learning models for different purposes (e.g., based on “multipurpose graph” embeddings generated via aggregation of multi-dimensional data representations of nodes), in accordance with one or more embodiments. In accordance with process 400, a computing device may use multiple node embedding generation techniques to create different sets of node embeddings that can be aggregated in a variety of ways. A variety of machine learning tasks can be performed using all of the features or different portions of the features in the aggregated node embeddings as appropriate for the task. By doing so, the efficiency of the computing system may be improved because creating a single multipurpose set of node embeddings eliminates the need for each machine learning application to have their own embeddings created. Process 400 of FIG. 4 may represent the actions taken by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 402, the computing system 102 may generate a first set of node embeddings. The first set of node embeddings may be generated using an unsupervised machine learning technique. For example, the computing system 102 may generate an unsupervised learning set of node embeddings by inputting data corresponding to graph nodes of a graph into an unsupervised embedding model. The first set of node embeddings may include a different node embedding for each node in a graph. In some embodiments, the first set of node embeddings may include a node embedding for each node of a portion of the nodes in the graph. The graph may include any graph, for example, as described above in connection with FIGS. 1-2. The first set of node embeddings may include any set of node embeddings described above, for example, in connection with FIGS. 1-2.

At step 404, the computing system 102 may generate a second set of node embeddings. The second set of node embeddings may be generated using a supervised machine learning technique. For example, the computing system 102 may generate a supervised learning set of node embeddings by inputting data corresponding to the graph nodes into a supervised embedding model. The second set of node embeddings may include a different node embedding for each node in a graph. In some embodiments, the second set of node embeddings may include a node embedding for each node of a portion of the nodes in the graph. Each node of the second set of node embeddings may include a second total number of features. The second total number of features may be the same number as the first total number of features described above in connection with step 402. Alternatively, the second total number of features may be a different number from the first total number of features. The second set of node embeddings may include any set of node embeddings described above, for example, in connection with FIGS. 1-2.

At step 406, the computing system 102 may aggregate the first set of node embeddings with the second set of node embeddings, for example, to create an aggregated set of node embeddings. The aggregated set of node embeddings may include an aggregated node embedding for each node of the graph. Each aggregated node embedding may have an aggregated set of features (e.g., values), for example, as described above in connection with FIGS. 1-2. An aggregated node embedding may include a greater number of features than either the first or second total number of features. For example, an aggregated node embedding may include a concatenation of a first node embedding from the first set of node embeddings with a second node embedding of the second set of node embeddings. In this example, the first node embedding and the second node embedding may correspond to the same node in the graph or different nodes in the graph. The aggregated set of node embeddings may include an aggregated set of node embeddings as described above, for example, in connection with FIGS. 1-2.

At step 408, the computing system 102 may select one or more feature subsets of the aggregated node embeddings. The computing system 102 may select different feature subsets of the aggregated node embeddings for different machine learning tasks. For example, the computing system 102 may select (i) a first feature subset as input parameters for a first machine learning model to predict a first target, (ii) a second feature subset as input parameters for the second machine learning model to predict a second target, or (iii) one or more other feature subsets as input parameters for one or more other respective machine learning models. The first and second machine learning model may be any model and may perform any task described above in connection with FIGS. 1-2.

At step 410, the computing system 102 may configure one or more machine learning models based on the feature subsets selected in step 408. The computing system 102 may use the machine learning subsystem 114 to train the first machine learning model to perform the first task. For example, the first machine learning model may be trained to identify a banking product to recommend to a user (e.g., a banking product described above in connection with FIG. 1).

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: generating, based on a graph comprising a plurality of nodes, a first set of node embeddings and a second set of node embeddings; aggregating the first set of node embeddings and the second set of node embeddings into an aggregated set of node embeddings.
2. The method of the preceding embodiment, further comprising: selecting a feature subset of the aggregated set of node embeddings for a target related to a machine learning model, wherein selecting the feature subset comprises: (i) in response to the target being a first target and the machine learning model being a first machine learning model, selecting a first feature subset of the aggregated set of features as input parameters for the first machine learning model to predict the first target; (ii) in response to the target being a second target different from the first target and the machine learning model being a second machine learning model different from the first machine learning model, selecting a second feature subset of the aggregated set of features as input parameters for the second machine learning model to predict the second target.
3. The method of any of the preceding embodiments, wherein aggregating the first set of node embeddings and the second set of node embeddings into the aggregated set of node embeddings comprises: concatenating a first node embedding from the first set of node embeddings with a second node embedding from the second set of node embeddings to form an aggregated node embedding, wherein the first node embedding and the second node embedding correspond to the same node.
4. The method of any of the preceding embodiments, wherein aggregating the first set of node embeddings and the second set of node embeddings into the aggregated set of node embeddings comprises: generating a linear combination of a first node embedding from the first set of node embeddings and a second node embedding from the second set of node embeddings, wherein the first node embedding and the second node embedding correspond to the same node.
5. The method of any of the preceding embodiments, wherein aggregating the first set of node embeddings and the second set of node embeddings into the aggregated set of node embeddings comprises: averaging a first node embedding from the first set of node embeddings with a second node embedding from the second set of node embeddings, wherein the first node embedding and the second node embedding correspond to the same node.
6. The method of any of the preceding embodiments, further comprising: generating a user interface for display at a user device, wherein the user interface comprises an indication of a subset of features of the aggregated set of node embeddings used by the first machine learning model; and receiving, via the user interface, an indication of a feature to remove from the subset of features.
7. The method of any of the preceding embodiments, wherein the graph comprises a set of edges, the method further comprising: generating, via a first machine learning model and based on the aggregated set of node embeddings, a recommendation for a new edge to be added to the set of edges, wherein the new edge connects a first node and a second node of the graph.
8. The method of any of the preceding embodiments, further comprising: determining, based on data associated with the graph, a set of labels by: determining, based on data associated with a first node, that a first feature is greater than a threshold feature value; and based on determining that the first feature is greater than a threshold feature value, assigning a first label to the first node; and training the second embedding model using a dataset that comprises the set of labels.
9. The method of any of the preceding embodiments, wherein selecting the first feature subset comprises: determining that a performance threshold is satisfied after training the first machine learning model based on the first feature subset; and selecting the first feature subset based on the performance threshold being satisfied.
10. The method of any of the preceding embodiments, wherein configuring the machine learning model with the feature subset comprises: training, based on the first feature subset, the first machine learning model to generate recommendations.
11. The method of any of the preceding embodiments, wherein selecting the second feature subset comprises: generating a matrix of eigenvectors associated with the aggregated set of node embeddings; and determining a subset of features of the aggregated set of features, wherein each determined feature corresponds to an eigenvector of a threshold number of eigenvectors.
12. The method of any of the preceding embodiments, further comprising: determining a plurality of subsets of the aggregated set of features, wherein each subset of the plurality of subsets corresponds to a given machine learning model of a plurality of machine learning models; and training, based on the plurality of subsets, the plurality of machine learning models to perform actions, wherein each machine learning model of the plurality of machine learning models is trained using a corresponding subset of the plurality of subsets.
13. A tangible, non-transitory, machine-readable medium storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A machine learning system for facilitating configuration of machine learning models for different purposes based on multipurpose node embeddings generated via aggregation of multi-dimensional data representations of nodes, the machine learning system comprising:
one or more processors; and
a non-transitory, computer readable medium having instructions recorded thereon that, when executed by the one or more processors, cause operations comprising:
generating an unsupervised learning set of node embeddings by inputting data corresponding to graph nodes of a graph into an unsupervised embedding model, the unsupervised learning set of node embeddings comprising a first node embedding for each node of the graph nodes, each of the first node embeddings having a first total number of features;
generating a supervised learning set of node embeddings by inputting data corresponding to the graph nodes into a supervised embedding model, the supervised learning set of node embeddings comprising a second node embedding for each node of the graph nodes, each of the second node embeddings having a second total number of features;
aggregating the unsupervised learning set of node embeddings and the supervised learning set of node embeddings into an aggregated set of node embeddings, the aggregated set of node embeddings comprising an aggregated node embedding for each node of the graph nodes, each of the aggregated set of node embeddings having an aggregated set of features comprising a greater number of features than a greater of the first or second total number of features; and
configuring first and second machine learning models based on first and second feature subsets of the aggregated set of features, respectively, wherein configuring the first machine learning model comprises selecting (i) the first feature subset as input parameters for the first machine learning model to predict a first target and (ii) the second feature subset as input parameters for the second machine learning model to predict a second target different from the first target.

2. A method comprising:
generating, based on a graph comprising a plurality of nodes, a first set of node embeddings via a first embedding model and a second set of node embeddings via a second embedding model different from the first embedding model;
aggregating the first set of node embeddings and the second set of node embeddings into an aggregated set of node embeddings, the aggregated set of node embeddings comprising an aggregated node embedding for each node of the plurality of nodes, each node embedding of the aggregated set of node embeddings having an aggregated set of features; and
selecting a feature subset of the aggregated set of features as input parameters for a machine learning model to predict a target, wherein selecting the feature subset comprises:
(i) in response to the target being a first target and the machine learning model being a first machine learning model, selecting a first feature subset of the aggregated set of features as input parameters for the first machine learning model to predict the first target;
(ii) in response to the target being a second target different from the first target and the machine learning model being a second machine learning model different from the first machine learning model, selecting a second feature subset of the aggregated set of features as input parameters for the second machine learning model to predict the second target; and
configuring, based on the selection of the feature subset, the machine learning model with the feature subset as input parameters for the machine learning model.

3. The method of claim 2, wherein aggregating the first set of node embeddings and the second set of node embeddings into the aggregated set of node embeddings comprises:
concatenating a first node embedding from the first set of node embeddings with a second node embedding from the second set of node embeddings to form an aggregated node embedding, wherein the first node embedding and the second node embedding correspond to the same node.

4. The method of claim 2, wherein aggregating the first set of node embeddings and the second set of node embeddings into the aggregated set of node embeddings comprises:
generating a linear combination of a first node embedding from the first set of node embeddings and a second node embedding from the second set of node embeddings, wherein the first node embedding and the second node embedding correspond to the same node.

5. The method of claim 2, wherein aggregating the first set of node embeddings and the second set of node embeddings into the aggregated set of node embeddings comprises:
averaging a first node embedding from the first set of node embeddings with a second node embedding from the second set of node embeddings, wherein the first node embedding and the second node embedding correspond to the same node.

6. The method of claim 2, further comprising:
generating a user interface for display at a user device, wherein the user interface comprises an indication of a subset of features of the aggregated set of node embeddings used by the first machine learning model; and
receiving, via the user interface, an indication of a feature to remove from the subset of features.

7. The method of claim 2, wherein the graph comprises a set of edges, the method further comprising:
generating, via a first machine learning model and based on the aggregated set of node embeddings, a recommendation for a new edge to be added to the set of edges, wherein the new edge connects a first node and a second node of the graph.

8. The method of claim 2, further comprising:
determining, based on data associated with the graph, a set of labels by:
determining, based on data associated with a first node, that a first feature is greater than a threshold feature value; and
based on determining that the first feature is greater than a threshold feature value, assigning a first label to the first node; and
training the second embedding model using a dataset that comprises the set of labels.

9. The method of claim 2, wherein selecting the first feature subset comprises:
determining that a performance threshold is satisfied after training the first machine learning model based on the first feature subset; and
selecting the first feature subset based on the performance threshold being satisfied.

10. The method of claim 2, wherein configuring the machine learning model with the feature subset comprises:
training, based on the first feature subset, the first machine learning model to generate recommendations.

11. The method of claim 2, wherein selecting the second feature subset comprises:
generating a matrix of eigenvectors associated with the aggregated set of node embeddings; and
determining a subset of features of the aggregated set of features, wherein each determined feature corresponds to an eigenvector of a threshold number of eigenvectors.

12. The method of claim 2, further comprising:
determining a plurality of subsets of the aggregated set of features, wherein each subset of the plurality of subsets corresponds to a given machine learning model of a plurality of machine learning models; and
training, based on the plurality of subsets, the plurality of machine learning models to perform actions, wherein each machine learning model of the plurality of machine learning models is trained using a corresponding subset of the plurality of subsets.

13. A non-transitory, computer-readable medium comprising instructions that when executed by one or more processors, causes operations comprising:
generating, based on a plurality of nodes, a first set of node embeddings via a first embedding model and a second set of node embeddings via a second embedding model;
aggregating the first set of node embeddings and the second set of node embeddings into an aggregated set of node embeddings, the aggregated set of node embeddings comprising an aggregated node embedding for each node of the plurality of nodes, each node embedding of the aggregated set of node embeddings having an aggregated set of features; and
selecting a feature subset of the aggregated set of features as input parameters for a machine learning model to predict a target, wherein selecting the feature subset comprises:
(i) in response to the target being a first target or the machine learning model being a first machine learning model, selecting a first feature subset of the aggregated set of features as input parameters for the machine learning model to predict the target;
(ii) in response to the target being a second target or the machine learning model being a second machine learning model, selecting a second feature subset of the aggregated set of features as input parameters for the machine learning model to predict the target; and
configuring, based on the selection of the feature subset, the machine learning model with the feature subset as input parameters for the machine learning model.

14. The medium of claim 13, wherein aggregating the first set of node embeddings and the second set of node embeddings into the aggregated set of node embeddings comprises:
concatenating a first node embedding from the first set of node embeddings with a second node embedding from the second set of node embeddings to form an aggregated node embedding, wherein the first node embedding and the second node embedding correspond to the same node.

15. The medium of claim 13, wherein aggregating the first set of node embeddings and the second set of node embeddings into the aggregated set of node embeddings comprises:
generating a linear combination of a first node embedding from the first set of node embeddings and a second node embedding from the second set of node embeddings, wherein the first node embedding and the second node embedding correspond to the same node.

16. The medium of claim 13, wherein aggregating the first set of node embeddings and the second set of node embeddings into the aggregated set of node embeddings comprises:
averaging a first node embedding from the first set of node embeddings with a second node embedding from the second set of node embeddings, wherein the first node embedding and the second node embedding correspond to the same node.

17. The medium of claim 13, wherein the instructions, when executed, cause operations further comprising:
generating a user interface for display at a user device, wherein the user interface comprises an indication of a subset of features of the aggregated set of node embeddings used by the first machine learning model.

18. The medium of claim 13, wherein a graph comprises the plurality of nodes and a set of edges, wherein the instructions, when executed, cause operations further comprising:
generating, via a first machine learning model and based on the aggregated set of node embeddings, a recommendation for a new edge to be added to the set of edges, wherein the new edge connects a first node and a second node of the graph.

19. The medium of claim 13, wherein the instructions, when executed, cause operations further comprising:
determining, based on data associated with the graph, a set of labels by:
determining, based on data associated with a first node, that a first feature is greater than a threshold feature value; and
based on determining that the first feature is greater than a threshold feature value, assigning a first label to the first node; and
training the second embedding model using a dataset that comprises the set of labels.

20. The medium of claim 13, wherein the instructions, when executed, cause operations further comprising:
determining a plurality of subsets of the aggregated set of features, wherein each subset of the plurality of subsets corresponds to a given machine learning model of a plurality of machine learning models; and
training, based on the plurality of subsets, the plurality of machine learning models to perform actions, wherein each machine learning model of the plurality of machine learning models is trained using a corresponding subset of the plurality of subsets.
